(19) United States
(12) Patent Application Publication
(10) Pub. No.: US 2025/0353361 A1
(43) Pub. Date: Nov. 20, 2025

(54) Automatic Sunshield Device

(71) Applicant: Farah Carter, Las Vegas, NV (US)

(72) Inventor: Farah Carter, Las Vegas, NV (US)

(21) Appl. No.: 19/211,719

(22) Filed: May 19, 2025

Related U.S. Application Data
(60) Provisional application No. 63/649,644, filed on May 20, 2024.

(51) Int. Cl. B60J 1/20

(52) U.S. Cl. CPC B60J 1/2077; B60J 1/2016; B60J 1/2019; B60J 1/2041; B60J 1/2052

(57) ABSTRACT

An automatic sunshield device is disclosed, which is a unique sunshield that protects the interior upholstery of a vehicle. The automatic sunshield device comprises first and second body components that are configured to slide out on tracks installed on opposite sides of the front and rear windshields to protect the vehicle when in a parked position. The body components would run on a track above and below the vehicle windshield, residing in the front frames of the vehicle, so it would remain invisible when not in use. The two body components of sunshield material would roll out and meet in the middle to interlock like puzzle pieces to create a total shield from sunlight. Movement of the body components is facilitated by the vehicle motor or an independent motor.

### CROSS-REFERENCE TO RELATED APPLICATION

The present application claims priority to, and the benefit of, U.S. Provisional Application No. 63/649,644, which was filed on May 20, 2024, and is incorporated herein by reference in its entirety.

### FIELD OF THE INVENTION

The present invention relates generally to the field of automatic sunshield devices. More specifically, the present invention relates to a flexible sunshield that will protect and cool the inside of the vehicle from undesirable high temperatures and damaging UV rays. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in automatic sunshield devices. Generally, vehicles are an expensive investment, and drivers may want to maximize protection against weather elements like rain, snow, excessive sunlight, and more. Further, interior leather can get cracked and look discolored if a vehicle is consistently left outdoors exposed to the sun's UV rays. Additionally, when a person gets in their vehicle after it is parked in the sun, the interior can be incredibly hot and uncomfortable. Furthermore, plastic construction inside the vehicle can begin to warp and crack due to excessive heat exposure.

Accordingly, impinging sunlight has several adverse effects on automobiles. One adverse effect is the strain caused to the drivers and the passengers while driving. Other adverse effects from impinging sun light include the bleaching effect on the fabric of the automobile's interior as well as causing a glass-house effect, wherein the interior heats up to a level that is highly uncomfortable to human beings.

Accordingly, there is a demand for an improved automatic sunshield device that is stored out of sight when not in use. More particularly, there is a demand for an automatic sunshield device that comprises tracks above and below the windshield that the sunshield runs along during use.

Therefore, there exists a long felt need in the art for an automatic sunshield device that provides users with a durable and flexible sunshield component that will protect and cool the inside of the vehicle from undesirable high temperatures and damaging UV rays. There is also a long felt need in the art for an automatic sunshield device that is designed with an innovative interlocking design to keep all sun rays out when they meet together in the middle point of contact. Further, there is a long felt need in the art for an automatic sunshield device that features a set of out of view tracks above and below the windshield that runs along the length of the front and rear glass allowing the shield to run on them. Moreover, there is a long felt need in the art for a device that will be stored out of sight of a consumer in the front and back frames of the car when not in use. Further, there is a long felt need in the art for an automatic sunshield device that can be automatically retracted as soon as the key fob is used to unlock the doors. Finally, there is a long felt need in the art for an automatic sunshield device that prevents the use of conventional bulky sunshades that don't keep out all of the sun.

The subject matter disclosed and claimed herein, in one embodiment thereof, comprises an automatic sunshield device. The device is a unique sunshield to protect the interior upholstery of a vehicle. The automatic sunshield device comprises first and second body components that are configured to slide out on tracks installed on opposite sides of the front and rear windshields to protect the vehicle when in a parked position. The body component comprises two sturdy pieces of sunproof material to protect the vehicle from heat and sun damage. The body component would run on a track above and below the vehicle windshield, residing in the front frames of the vehicle, so it would remain invisible when not in use. The two body components of sunshield material would roll out and meet in the middle to interlock like puzzle pieces to create a total shield from sunlight. A flexible molded area would accommodate a rearview mirror. The device can expand over both the front and rear windows to create optimal protection. Movement of the body components is facilitated by the vehicle motor or an independent motor. The device is automatically activated after turning off the vehicle, but an internal manual button or key fob can control the device, as well.

In this manner, the automatic sunshield device of the present invention accomplishes all of the forgoing objectives and provides users with an automatic sunshield that runs on tracks to cover a vehicle windshield. The device covers both the front and rear windows of the vehicle. The device can comprise a durable and flexible sunproof material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automatic sunshield device. The automatic sunshield device comprises first and second body components that are configured to slide out on tracks installed on opposite sides of the front and rear windshields to protect the vehicle when in a parked position. Thus, the body component comprises two sturdy pieces of sunproof material to protect the vehicle from heat and sun damage. The device can expand over both the front and rear windows to create optimal protection. Movement of the body components is facilitated by the vehicle motor or an independent motor.

In one embodiment, the automatic sunshield device is a unique sunshield that protects the interior upholstery of a vehicle. The device prevents users from having to fight with conventional bulky sunshades that don't keep out all of the sunlight. When not in use, the device is stored in the vehicle's frames and remains invisible. Then when needed, the device is extended out from the vehicle's frames to meet in the middle to create a total shield from sunlight.

In one embodiment, the automatic sunshield device is a motorized sunshade/sunshield that is attached to a vehicle's windshield and/or rear window. The device is typically powered by being tied into (i.e., communicating with) the vehicle's battery, wherein the battery provides the electrical power necessary for operation of the motor. Thus, the battery powers the motor and allows a user to selectively raise and lower the sunshield on either or both the front and back vehicle windows to shield the interior from sunlight, as needed.

In one embodiment, the automatic sunshield device comprises an independent electric motor and a linear actuator, or other suitable motion transferring mechanism as is known in the art. The device is linked to the electric motor to extend and retract the sunshield device. According to the invention, the device is extended across the windshield and/or back window and retracted from the windshield and/or back window via the electric motor.

In one embodiment, the automatic sunshield device is in communication with the vehicle motor to extend and retract the sunshield device. According to the invention, the device is extended across the windshield and/or back window and retracted from the windshield and/or back window via the vehicle motor.

In one embodiment, the automatic sunshield device comprises a pair of body components, which act to cover the front window (i.e., windshield), and a pair of body components which act to cover the rear window. The pair of body components include a right and left body component. The body components can be any suitable shape and size, as long as they are shaped and sized to cover the entire window when in an extended position. Typically, each body component is configured in a rectangular shape when fully extended.

In one embodiment, the body components are manufactured of a plastic, sunproof material, which is flexible and durable. Typically, the body components comprise two sturdy but thin pieces of sunshield material.

In one embodiment, the automatic sunshield device comprises a pair of elongated tracks securely mounted above and below the vehicle window. The tracks span a width of the vehicle windshield and back window. The tracks would be secured to the interior of the vehicle front and rear windows via glue, adhesives, screws on the frame, etc. Typically, the tracks are positioned such that they are unseen and non-obtrusive to the driver/user. Further, the tracks have an interior slot or channel that secures the body components with a roller component, allowing the body components to extend and retract, as needed. Specifically, the body components would be rolled up within the track when not in use and would reside in the front frames of the vehicle, such that they remain invisible. Then, during use, the body components would run on the tracks above and below the window, as needed.

In one embodiment, in an extended position, the body components meet in the middle to create a total shield from sunlight for the interior of the vehicle. Typically, the two body components interlock when they meet in the middle, similar to puzzle pieces to keep the sunlight out completely. Specifically, one of the body components comprises at least one protrusion at an interior edge and the corresponding body component comprises at least one notched area for accepting the protrusion at its interior edge. Thus, the body components can then interlock via the protrusions and corresponding notched areas to form the complete sunshield to block out sunlight.

In one embodiment, the body components comprise a flexible area to accommodate the rearview mirror of the vehicle. As is well known to most vehicle drivers, each vehicle comes with a factory-installed rearview mirror that is generally mounted on the windshield. Unfortunately, mounting the rearview mirror to the windshield obstructs the sunshield device from being extended fully across the windshield. Specifically, the flexible area is positioned in the upper center of the body components and surrounds the post and base of the rearview mirror when in an extended position, to allow the sunshield device to completely cover the windshield. Typically, the flexible area is manufactured of a flexible material, such as rubber, neoprene, etc.

In one embodiment, the automatic sunshield device is automatically activated and is totally hands-free to the user. The device retracts when the vehicle is turned on and deploys or extends when the vehicle is turned off.

In one embodiment, the automatic sunshield device comprises a manual button positioned within the vehicle's interior. The button is connected to the motor, such that activating the button causes activation of the motor. According to the invention, the button allows the user to activate the motor, so as to selectively extend and/or retract the body components of the sunshield device.

In one embodiment, the automatic sunshield device can be controlled by a user's key fob. The automatic sunshield device is in communication with the key fob, such that users can depress the key fob to extend and/or retract the sunshield device. In one embodiment, the sunshield device can be automatically retracted when a user unlocks the vehicle doors via the key fob. Accordingly, as soon as the key fob is utilized to unlock the vehicle doors, the sunshield device would already be retracted out of the way by the time a user enters the vehicle and buckles in.

In one embodiment, the automatic sunshield device includes a wireless communications module and additional sensors which would allow the device to pair with a mobile application on a smart device. Once paired, a user could control the automatic sunshield device via the mobile application.

In yet another embodiment, the automatic sunshield device comprises a plurality of indicia.

In yet another embodiment, a method of automatically shielding a vehicle from sunlight is disclosed. The method includes the steps of providing an automatic sunshield device comprising two body components which run on tracks located on the interior of the windshield. The method also comprises manually pressing a button or key fob to extend the body components. Further, the method comprises extending the body components along the tracks toward the center of the vehicle's windshield and/or back window. The method also comprises securing the flexible area around the rearview mirror. Finally, the method comprises interlocking the body components to create a total shield from sunlight.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the automatic sunshield device of the present invention in accordance with the disclosed architecture;

FIG. 2 illustrates a perspective view of one embodiment of the automatic sunshield device of the present invention showing the open windshield of the vehicle in accordance with the disclosed architecture;

FIG. 3 illustrates a perspective view of one embodiment of the automatic sunshield device of the present invention showing the device expanding across the windshield in accordance with the disclosed architecture;

FIG. 4 illustrates a perspective view of one embodiment of the automatic sunshield device of the present invention showing the flexible section that molds around the rearview mirror in accordance with the disclosed architecture;

FIG. 5 illustrates a perspective view of one embodiment of the automatic sunshield device of the present invention showing the interlocking body components in accordance with the disclosed architecture; and

FIG. 6 illustrates a flowchart showing the method of automatically shielding a vehicle from sunlight in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an automatic sunshield device that provides users with a durable and flexible sunshield component that will protect and cool the inside of the vehicle from undesirable high temperatures and damaging UV rays. There is also a long felt need in the art for an automatic sunshield device that is designed with an innovative interlocking design to keep all sun rays out when they meet together in the middle point of contact. Further, there is a long felt need in the art for an automatic sunshield device that features a set of out of view tracks above and below the windshield that runs along the length of the front and rear glass allowing the shield to run on them. Moreover, there is a long felt need in the art for a device that will be stored out of sight of a consumer in the front and back frames of the car when not in use. Further, there is a long felt need in the art for an automatic sunshield device that can be automatically retracted as soon as the key fob is used to unlock the doors. Finally, there is a long felt need in the art for an automatic sunshield device that prevents the use of conventional bulky sunshades that don't keep out all of the sun.

The present invention, in one exemplary embodiment, is a novel automatic sunshield device. The automatic sunshield device comprises first and second body components that are configured to slide out on tracks installed on opposite sides of the front and rear windshields to protect the vehicle when in a parked position. The body component would run on a track above and below the vehicle windshield, residing in the front frames of the vehicle, so it would remain invisible when not in use. The two body components of sunshield material would roll out and meet in the middle to interlock like puzzle pieces to create a total shield from sunlight. A flexible molded area would accommodate a rearview mirror. Movement of the body components is facilitated by the vehicle motor or an independent motor. An internal manual button or key fob can control the device. The present invention also includes a novel method of automatically shielding a vehicle from sunlight. The method includes the steps of providing an automatic sunshield device comprising two body components which run on tracks located on the interior of the windshield. The method also comprises manually pressing a button or key fob to extend the body components. Further, the method comprises extending the body components along the tracks toward the center of the vehicle's windshield and/or back window. The method also comprises securing the flexible area around the rearview mirror. Finally, the method comprises interlocking the body components to create a total shield from sunlight.

Referring initially to the drawings, FIG. 1 illustrates a perspective view of one embodiment of the automatic sunshield device 100 of the present invention. In the present embodiment, the automatic sunshield device 100 is an improved automatic sunshield device 100 that provides a user with a unique sunshield to protect the interior upholstery of a vehicle. Specifically, the automatic sunshield device 100 comprises a pair of body components 102, 103 and an attached track 104 installed on opposite sides (i.e., top 112 and bottom 114) of the front 106 and rear 108 windshields to protect the vehicle 110 when in a parked position. Thus, the body component 102, 103 comprises two sturdy pieces of sunproof material to protect the vehicle 110 from heat and sun damage. The device 100 can expand over both the front 106 and rear 108 windows to create optimal protection.

Generally, the automatic sunshield device 100 is a unique sunshield that protects the interior upholstery of a vehicle 110. The device 100 prevents users from having to fight with conventional bulky sunshades that don't keep out all of the sunlight. When not in use, the device 100 is stored in the vehicle's frames 116 and remains invisible. Then when needed, the device 100 is extended out from the vehicle's frames 116 to meet in the middle to create a total shield from sunlight.

Further, the automatic sunshield device 100 is a motorized sunshade/sunshield that is attached to a vehicle's windshield 106 and/or rear window 108. The device 100 is typically powered by being tied into (i.e., communicating with) the vehicle's battery 118, wherein the battery 118 provides the electrical power necessary for operation of the motor 120, 122. Thus, the battery 118 powers the motor 120, 122 and allows a user to selectively raise and lower the sunshield on either or both the front 106 and back 108 vehicle windows to shield the interior from sunlight, as needed.

Additionally, in one embodiment, the automatic sunshield device 100 comprises an independent electric motor 120 and a linear actuator 124, or other suitable motion transferring mechanism as is known in the art. The device 100 is linked to the electric motor 120 to extend and retract the sunshield device 100. According to the invention, the device 100 is extended across the windshield 106 and/or back window 108 and retracted from the windshield 106 and/or back window 108 via the electric motor 120.

In another embodiment, the automatic sunshield device 100 is in communication with the vehicle motor 122 to extend and retract the sunshield device 100. According to the invention, the device 100 is extended across the windshield 106 and/or back window 108 and retracted from the windshield 106 and/or back window 108 via the vehicle motor 122.

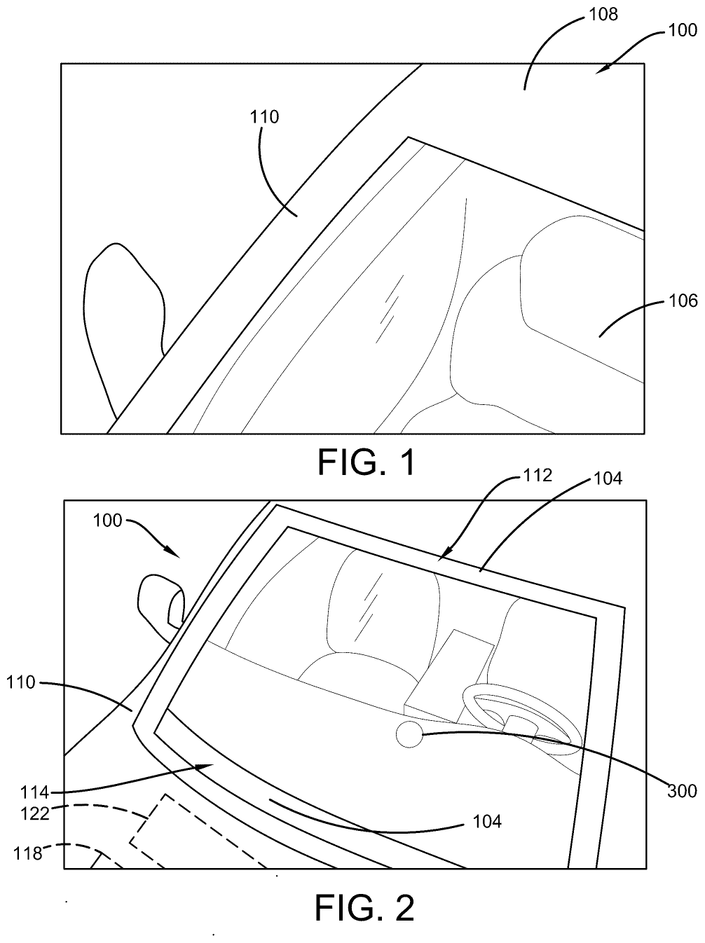

As shown in FIG. 2, the automatic sunshield device 100 comprises a pair of body components 102, 103, which act to cover the front window 106 (i.e., windshield), and a pair of body components 102, 103 which act to cover the rear window 108. The pair of body components 102, 103 include a right 102 and left 103 body component. The body components 102, 103 can be any suitable shape and size, as long as they are shaped and sized to cover the entire window 106, 108 when in an extended position. Typically, each body component 102, 103 is configured in a rectangular shape when fully extended.

Further, the body components 102, 103 are manufactured of a sun proof, thin, flexible polyurethane based product that can withstand, absorb, deflect high temperatures, block out 99% of the sun's damaging UV rays, is 100% paraben free, and can lower the cabin temperatures as much as 25 to 40% during the hottest summer months. This material is also known for it's ability to withstand high levels of activity, as such as being rolled up and flattened down repeatedly over a long period of time without warping, tearing, or becoming chemically compromised. The material also holds its integrity when exposed to extended periods of intense heat or cool temperatures and is unaffected by dry or humid climates.

Additionally, the automatic sunshield device 100 comprises a pair of elongated tracks 104 securely mounted above 112 and below 114 the vehicle window. The tracks 104 span a width of the vehicle windshield 106 and back window 108. The tracks 104 would be secured to the interior of the vehicle front 106 and rear 108 windows via glue, adhesives, screws on the frame, etc. Typically, the tracks 104 are positioned such that they are unseen and non-obtrusive to the driver/user. Further, the tracks 104 have an interior slot or channel 126 that secures the body components 102, 103 with a roller component 128, allowing the body components 102, 103 to extend and retract, as needed. Specifically, the body components 102, 103 would be rolled up within the track 104 when not in use and would reside in the front frames 116 of the vehicle 110, such that they remain invisible. Then, during use, the body components 102, 103 would run on the tracks 104 above 112 and below 114 the window, as needed.

Further the pair of elongated tracks 104 will run an entire length of the upper 112 and 114 lower front 106 and rear 108 windows and are built into the vehicle 110 by manufacturer to be slightly imbedded and out-of-site at all times. The roller component 128 will begin to rotate as soon as the vehicle 110 is turned on, pulling the body components 102, 103 inside the front frames 116 and out of sight.

There will also be anywhere from 3 to 5 skinnier metal strips 105 that will be sandwiched in between the body components 102, 103 a few inches apart that will also be riding in the channels 126 to keep the body components 102, 103 flush with the window 106 or 108. This provides back up if one body component 102 or 103 is compromised and creates thermal insulation which adds an extra level of environmental protection from outside temperatures.

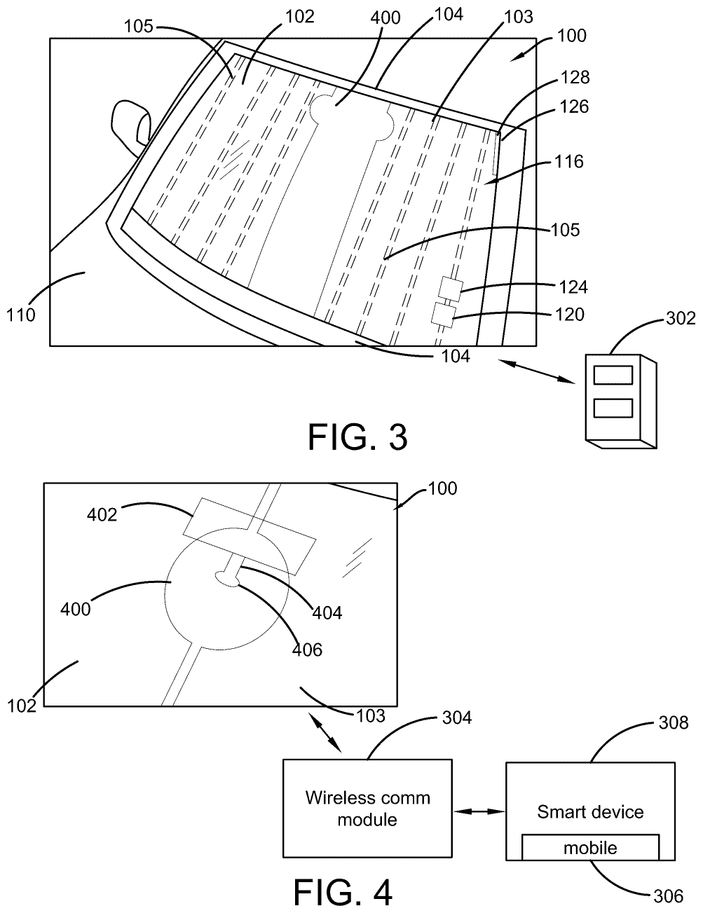

As shown in FIG. 3, the automatic sunshield device 100 is automatically activated and is totally hands-free to the user. The device 100 retracts when the vehicle 110 is turned on and deploys or extends when the vehicle 110 is turned off.

In one embodiment, the automatic sunshield device 100 comprises a manual button 300 positioned within the vehicle's interior. The button 300 is connected to the motor 120 or 122, such that activating the button 300 causes activation of the motor 120 or 122. According to the invention, the button 300 allows the user to activate the motor 120 or 122, so as to selectively extend and/or retract the body components 102, 103 of the sunshield device 100.

In one embodiment, the automatic sunshield device 100 can be controlled by a user's key fob 302. The automatic sunshield device 100 is in communication with the key fob 302, such that users can depress the key fob 302 to extend and/or retract the sunshield device 100. In one embodiment, the sunshield device 100 can be automatically retracted when a user unlocks the vehicle doors via the key fob 302. Accordingly, as soon as the key fob 302 is utilized to unlock the vehicle doors, the sunshield device 100 would already be retracted out of the way by the time a user enters the vehicle 110 and buckles in.

In another embodiment, the automatic sunshield device 100 includes a wireless communications module 304 and additional sensors which would allow the device 100 to pair with a mobile application 306 on a smart device 308. Once paired, a user could control the automatic sunshield device 100 via the mobile application 306.

As shown in FIG. 4, the body components 102, 103 comprise a flexible area 400 to accommodate the rearview mirror 402 of the vehicle 110. As is well known to most vehicle drivers, each vehicle 110 comes with a factory-installed rearview mirror 402 that is generally mounted on the windshield 106. Unfortunately, mounting the rearview mirror 402 to the windshield 106 obstructs the sunshield device 100 from being extended fully across the windshield 106. Specifically, the flexible area 400 is positioned in the upper center of the body components 102, 103 and surrounds the post 404 and base 406 of the rearview mirror 402 when in an extended position, to allow the sunshield device 100 to completely cover the windshield 106. Typically, the flexible area 400 is manufactured of a flexible material, such as rubber, neoprene, etc.

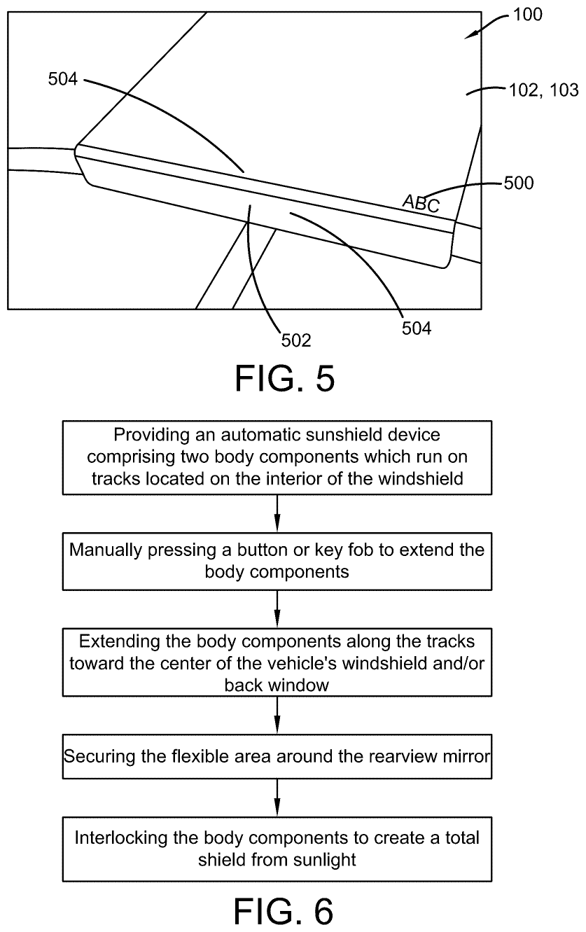

As shown in FIG. 5, in an extended position, the body components 102, 103 meet in the middle to create a total shield from sunlight for the interior of the vehicle 110. Typically, the two body components 102, 103 interlock when they meet in the middle, similar to puzzle pieces to keep the sunlight out completely. Specifically, one of the body components 102 comprises at least one protrusion 502 at an interior edge 504 and the corresponding body component 103 comprises at least one notched area 506 for accepting the protrusion 502 at its interior edge 504. Thus, the body components 102, 103 can then interlock via the protrusions 502 and corresponding notched areas 506 to form the complete sunshield to block out sunlight. The interlocking protrusion 502 and notched area 506 are dual purpose. They not only serve as a way to fit the two body components 102, 103 tightly together to block out all sunlight but, to also be a half an inch longer above and below the track 104 to act as the main pin that rides the body components 102, 103 along the track 104, out of the frame 116, and then to join in the middle like a puzzle piece. It will also be slightly magnetized for optimum adhesion.

In yet another embodiment, the automatic sunshield device 100 comprises a plurality of indicia 500. The body components 102 of the device 100 may include advertising, a trademark, or other letters, designs, or characters, printed, painted, stamped, or integrated into the body components 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be sunshield, vehicle, or brand related.

Further, the automatic sunshield device 100 is incorporated during manufacturing of the vehicle 110 and not an aftermarket design.

FIG. 6 illustrates a flowchart of the method of automatically shielding a vehicle from sunlight. The method includes the steps of at 600, providing an automatic sunshield device comprising two body components which run on tracks located on the interior of the windshield. The method also comprises at 602, manually pressing a button or key fob to extend the body components. Further, the method comprises at 604, extending the body components along the tracks toward the center of the vehicle's windshield and/or back window. The method also comprises at 606, securing the flexible area around the rearview mirror. Finally, the method comprises at 608, interlocking the body components to create a total shield from sunlight.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “automatic sunshield device”, “sunshield device”, “automatic device”, and “device” are interchangeable and refer to the automatic sunshield device 100 of the present invention.

Notwithstanding the forgoing, the automatic sunshield device 100 of the present invention can be of any suitable size and configuration as is known in the art without affecting the overall concept of the invention, provided that it accomplishes the above stated objectives. One of ordinary skill in the art will appreciate that the automatic sunshield device 100 as shown in FIGS. 1-6 is for illustrative purposes only, and that many other sizes and shapes of the automatic sunshield device 100 are well within the scope of the present disclosure. Although the dimensions of the automatic sunshield device 100 are important design parameters for user convenience, the automatic sunshield device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automatic sunshield device that provides a user with a unique sunshield to protect a vehicle's interior, the automatic sunshield device comprising:
a pair of body components; and
an attached track;
wherein the attached track is installed on a top and a bottom of a vehicle windshield; and
further wherein the pair of body components run on the attached track to expand over the vehicle windshield to protect an interior of a vehicle from sunlight.

2. The automatic sunshield device of claim 1, wherein the automatic sunshield device is in communication with a vehicle's battery for operation of a motor to selectively extend and retract the pair of body components across the vehicle windshield.

3. The automatic sunshield device of claim 2 further comprising an independent electric motor and a linear actuator, which acts to extend and retract the pair of body components across the vehicle windshield.

4. The automatic sunshield device of claim 2, wherein the automatic sunshield device is in communication with a vehicle motor to extend and retract the pair of body components across the vehicle windshield.

5. The automatic sunshield device of claim 2, wherein the pair of body components act to cover the front windshield or a rear windshield of a vehicle.

6. The automatic sunshield device of claim 5, wherein each of the pair of body components is configured in a rectangular shape when fully extended.

7. The automatic sunshield device of claim 6, wherein the pair of body components are manufactured of a plastic, sunproof material, which is flexible and durable.

8. The automatic sunshield device of claim 7, wherein the attached track spans a width of the vehicle windshield and is secured to an interior of the vehicle.

9. The automatic sunshield device of claim 8, wherein the attached track has an interior slot that secures the pair of body components with a roller component.

10. The automatic sunshield device of claim 9, wherein the pair of body components would be rolled up within the attached track when not in use and would reside in front frames of the vehicle, such that they remain invisible.

11. The automatic sunshield device of claim 10 further comprising a manual button positioned within vehicle's interior, which is connected to the motor.

12. The automatic sunshield device of claim 11, wherein the automatic sunshield device can be controlled by a user's key fob.

13. The automatic sunshield device of claim 12, wherein the pair of body components comprise a flexible area to accommodate a rearview mirror of the vehicle.

14. The automatic sunshield device of claim 13, wherein the pair of body components meet in a middle to interlock and create a total shield from sunlight.

15. An automatic sunshield device that provides a user with a unique sunshield to protect a vehicle's interior, the automatic sunshield device comprising:
a pair of body components which act to cover a front windshield and a rear windshield of a vehicle; and
an attached track which spans a width of the front and rear windshields and is secured to an interior of the vehicle;
wherein the pair of body components are manufactured of a plastic, sunproof material, which is flexible and durable;
wherein the attached track is installed on a top and a bottom of the front and rear windshields;
wherein the attached track has an interior slot that secures the pair of body components with a roller component;
wherein the automatic sunshield device is in communication with a vehicle's battery for operation of a vehicle's motor to selectively extend and retract the pair of body components across the front and rear windshields;
wherein the automatic sunshield device automatically deploys when the vehicle is turned off and retracts when the vehicle is turned on;
wherein the pair of body components comprise a flexible area to accommodate a rearview mirror of the vehicle;
wherein the pair of body components meet in a middle to interlock and create a total shield from sunlight; and
further wherein the pair of body components run on the attached track to expand over the front and rear windshields to protect an interior of a vehicle from sunlight.

16. The automatic sunshield device of claim 15, wherein the flexible area surrounds a post and a base of the rearview mirror when in an extended position, to allow the pair of body components to completely cover the front and rear windshields.

17. The automatic sunshield device of claim 15, wherein the pair of body components interlock in a middle via at least one protrusion at an interior edge which interlocks to at least one notched area.

18. The automatic sunshield device of claim 15 further comprising a wireless communications module and additional sensors which would allow the automatic sunshield device to pair with a mobile application on a smart device to control the automatic sunshield device via the mobile application.

19. The automatic sunshield device of claim 15 further comprising a plurality of indicia.

20. A method of automatically shielding a vehicle from sunlight, the method comprising the following steps:
providing an automatic sunshield device comprising two body components which run on tracks located on the interior of the windshield;
manually pressing a button or key fob to extend the body components;
extending the body components along the tracks toward the center of the vehicle's windshield and/or back window;
securing the flexible area around the rearview mirror; and
interlocking the body components to create a total shield from sunlight.
